(19) United States
(12) Patent Application Publication
(10) Pub. No.: US 2014/0298236 A1
(43) Pub. Date: Oct. 2, 2014

(54) SYSTEM AND METHOD FOR PROVIDING VIOLATION BAR IN A SUPPLY CHAIN MANAGEMENT ENVIRONMENT

(71) Applicant: M3 TECHNOLOGY, INC., Houston, TX (US)

(72) Inventors: David Jasper, Houston, TX (US); Steven Green, Houston, TX (US); Dong Dong, Sugar Land, TX (US)

(73) Assignee: M3 Technology, Inc., Houston, TX (US)

(21) Appl. No.: 13/855,609

(22) Filed: Apr. 2, 2013

(51) Int. Cl. G06F 3/0484

(52) U.S. Cl. CPC G06F 3/0484
USPC 715/772

(57) ABSTRACT

A system and method support a supply chain management platform for a supply chain management environment. A supply chain management platform can display the violation bar on a graphical user interface (GUI), wherein the violation bar operates to show one or more violations in a supply chain management environment. Furthermore, the supply chain management platform allows a user to interact with the violation bar in order to obtain detailed information on the one or more violations or launch a tool to resolve the one or more violations.

### FIELD OF THE INVENTION

This invention relates generally to supply chain management, and relates more particularly to supporting charting in a supply chain management environment.

### BACKGROUND

A supply chain describes the movement and storage of raw materials, work-in-process inventory, and finished goods from point of origin to point of consumption. A supply chain management environment can manage interconnected businesses and/or facilities involved in the provision of product and service packages in the supply chain. This is the general area that embodiments of the invention are intended to address.

### SUMMARY

Described herein are systems and methods that can support a violation bar in a supply chain management environment. A supply chain management platform can display the violation bar on a graphical user interface (GUI), wherein the violation bar operates to show one or more violations in a supply chain management environment. Furthermore, the supply chain management platform allows a user to interact with the violation bar in order to obtain detailed information on the one or more violations or launch a tool to resolve the one or more violations.

### BRIEF DESCRIPTION OF THE DRAWINGS

FIG. 1 is an exemplary illustration of supporting a violation bar in a supply chain management environment, in accordance with various embodiments of the invention.

FIG. 2 is an exemplary illustration of a flow diagram for supporting a violation bar in a supply chain management environment, in accordance with various embodiments of the invention.

FIG. 3 is an exemplary illustration of displaying an exemplary inventory limits violation bar in a supply chain management environment, in accordance with various embodiments of the invention.

FIG. 4 is an exemplary illustration of displaying an inventory projection report corresponding to an inventory limits violation bar, in accordance with various embodiments of the invention.

FIG. 5 is an exemplary illustration of displaying a supply & demand balance report corresponding to an inventory limits violation bar, in accordance with various embodiments of the invention.

FIG. 6 is an exemplary illustration of displaying detailed information for a violation shown on an inventory limits violation bar, in accordance with various embodiments of the invention.

FIG. 7 is an exemplary illustration of launching an inventory limits violation report, in accordance with various embodiments of the invention.

FIG. 8 is an exemplary illustration of displaying an inventory limits violation context menu for a violation shown in a violation bar, in accordance with various embodiments of the invention.

FIG. 9 is an exemplary illustration of launching a trend chart for a selected violation, in accordance with various embodiments of the invention.

FIG. 10 is an exemplary illustration of displaying an inventory limits violation bar with a warning to be resolved, in accordance with various embodiments of the invention.

FIG. 11 is an exemplary illustration of displaying the inventory limits violation bar after a warning is resolved, in accordance with various embodiments of the invention.

### DETAILED DESCRIPTION

The invention is illustrated by way of example and not by way of limitation in the figures of the accompanying drawings in which like references indicate similar elements. It should be noted that references to “an” or “one” or “some” embodiment(s) in this disclosure are not necessarily to the same embodiment, and such references mean at least one.

Supply chain management software, e.g. Planning Workspace Pro (PW Pro'), can provide a supply chain management platform for handling a wide range of supply chain activities and providing supply chain visibility. Furthermore, the supply chain management platform can be used for managing inventory, generating enterprise reports, and delivering real business intelligence.

In accordance with various embodiments of the invention, a supply chain management platform can display a violation bar for supporting supply chain management.

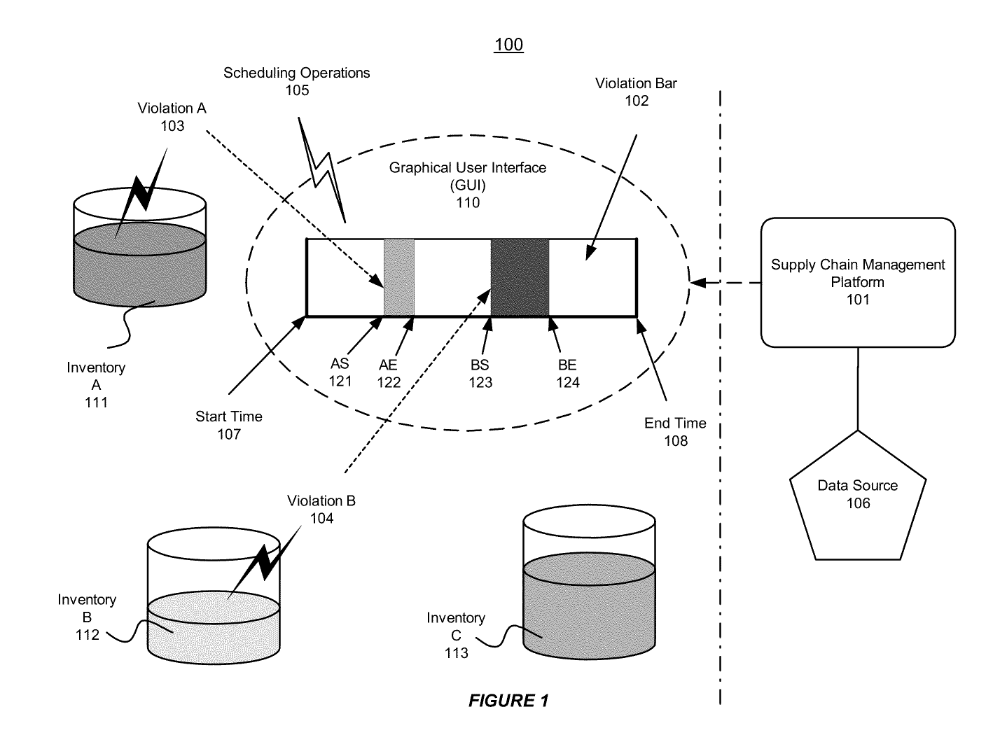

FIG. 1 is an exemplary illustration of supporting a violation bar in a supply chain management environment, in accordance with various embodiments of the invention. As shown in FIG. 1, a supply chain management platform 101 can be supported in a supply chain management environment 100 to manage different inventories, e.g. the inventories A-C 111-113. The supply chain management platform 101 can provide a graphical user interface (GUI) 110 that allows a user to perform one or more supply chain management operations, such as scheduling operations 105.

A violation bar 102, e.g. an inventory limits violation bar in PW Pro™, can be displayed on the GUI 110. The violation bar 103 can provide straight forward and visualized indication of supply chain limits violation information to the user. Additionally, the violation bar 103 can be displayed either on a conventional personal computer, or can be displayed remotely such as on a smart phone that can receive supply chain management information from a server.

In accordance with various embodiments of the invention, the supply chain management platform 101 allows a user to define a supply chain time window between a start time 107 and an end time 108. Then, the supply chain management platform 101 can determine one or more violations that may occur within the supply chain time window.

For example, in PW Pro™, the supply chain management platform 101 can calculate forecasted inventories of each material at each location within a given supply chain time window. These inventories can be verified against inventory limits, minimum and maximum, of the material at each location for different time points within the supply chain time window. If the forecasted inventory is greater than the maximum or less than the minimum at the corresponding time then an inventory limits violation has occurred.

In accordance with various embodiments of the invention, the violation bar 102 can be configured to display various violations, e.g. the violations A-B 103-104, which may occur within a supply chain time window, without requiring the user to open different reports, charts or error listings to determine whether there is any violation and what the existing violations are. Furthermore, the violation bar 102 may be configured to only show the highest priority violations for each time range.

As shown in FIG. 1, violation A 103 can be displayed on the violation bar 102 with a start time, AS 121, and an end time, AE 122; and Violation B 104 can be displayed on the violation bar 102 with a start time, BS 123, and an end time, BE 124. Here, the various start times and end times, AS 121 AE 122 BS 123 BE 124, are within the time range between the start time 107 and the end time 108.

In accordance with various embodiments of the invention, the violations, e.g. the violations A-B 103-104, can be shown color-coded on the violation bar 102 based on the violation priority. A user is allowed to configure the color for violations with different violation priority. For example, the violation bar 102 can be configured to show the violations with higher priority before the violations with lower priority. Also, the violation bar 102 may be configured to show only the violations with the highest priority for all materials at all locations within the supply chain time window.

Furthermore, the supply chain management platform 101 can update the violation bar 102 continuously in order to show the current violations within the supply chain time window. The supply chain management platform 101 can hide the violation bar 102 when no violations exist within the supply chain time window.

Additionally, the supply chain management platform 101 allows a user to interact with the violation bar 102 in order to obtain detailed information on various violations, and/or launch different tools to allow a user to perform various scheduling operations 105 in order to address the violations.

In accordance with various embodiments of the invention, the supply chain management platform 101 can rely on one or more data sources 106 for collecting and maintaining information on the different inventories A-C 111-113, at different locations.

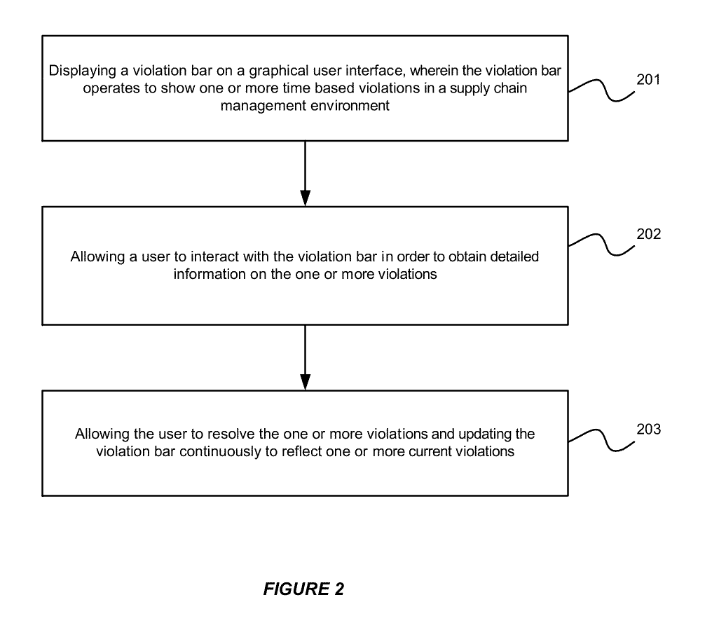

FIG. 2 is an exemplary illustration of a flow diagram for supporting a violation bar in a supply chain management environment, in accordance with various embodiments of the invention. As shown in FIG. 2, at step 201, the supply chain management platform can display a violation bar on a graphical user interface, wherein the violation bar operates to show one or more time based violations in a supply chain management environment. Then, at step 202, the supply chain management platform allows a user to interact with the violation bar in order to obtain detailed information on the one or more violations. Furthermore, at step 203, the supply chain management platform allows a user to resolve the one or more violations and update the violation bar continuously to reflect one or more current violations.

### Inventory Limits Violation Bar

In accordance with various embodiments of the invention, a violation bar, such as an inventory limits violation bar, can provide straight-forward indication on supply chain violation events to the user.

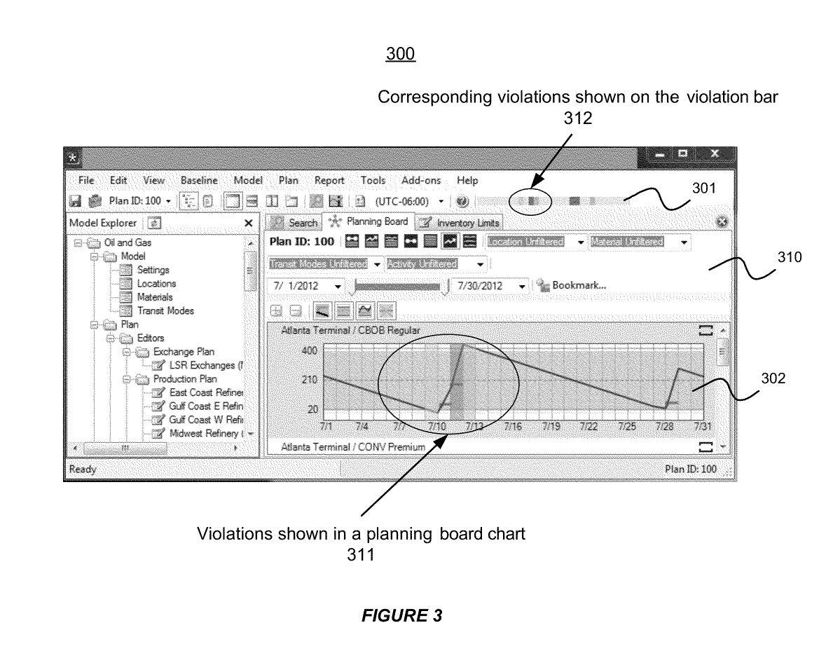

FIG. 3 is an exemplary illustration of displaying an inventory limits violation bar in a supply chain management environment, in accordance with various embodiments of the invention. As shown in FIG. 3, an inventory limits violation bar 301 can be displayed on a graphical user interface (GUI) 310, showing various inventory limits violation in a supply chain management environment 300. The various violations can be shown as different color stripes on the inventory limits violation bar 301. Each color stripe can have a position and a width corresponding to the time range that the violation occurs within the supply chain time window.

For example, there are three inventory limits violations shown respectively in the planning board chart 302, at the time points of “7/9,” “7/11,” and “7/12” (as emphasized in the ellipse 311). These inventory limits violations are related to the inventory of “Atlanta Terminal/CBOB Regular.” These violations can be shown using different color stripes (as emphasized in the ellipse 312) on the inventory limits violation bar 301. The locations of each color stripe on the inventory limits violation bar 301 reflect a corresponding time point that a violation occurs. Also, a consistent color scheme can be applied to the violations as shown both on the inventory limits violation bar 301 and in the planning board chart 302.

Additional violations can be shown on the inventory limits violation bar 301. These violations may correspond to the other inventories, such as “Atlanta Terminal/CNOV Premium,” which is not shown in FIG. 3. Thus, without a need of opening specific trend chart in the planning board chart 302, the user can be notified about the inventory limits violation events on the other inventories with approximated time information.

The colors (not shown) of these stripes can be coded to indicate the types of the violations. If multiple violations occur at the same time point, only the color corresponding to the violation with the highest priority may be shown. Additionally, the inventory limits violation bar 301 can be configured to show only the violations with the highest priority for all materials at all locations in the supply chain management environment 300.

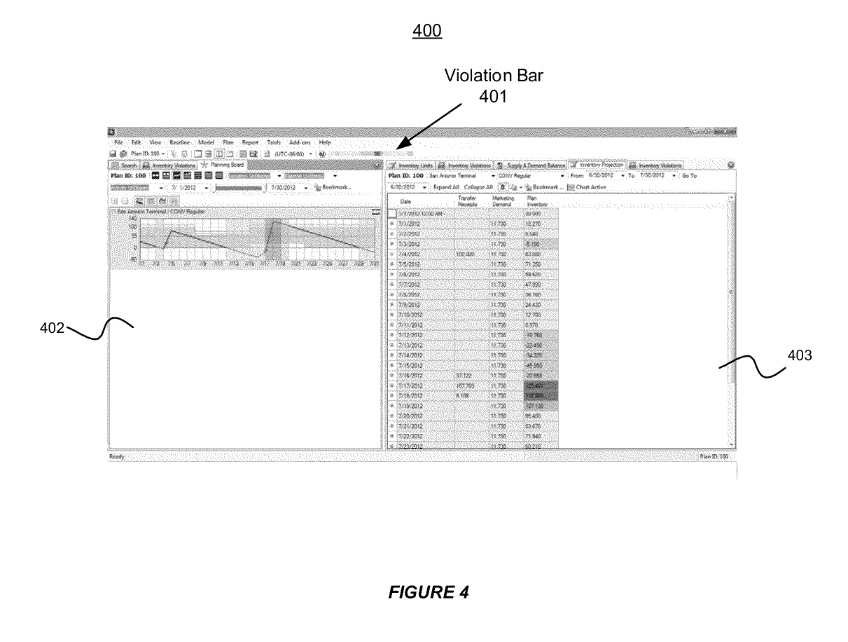

FIG. 4 is an exemplary illustration of displaying an inventory projection report corresponding to an inventory limits violation bar, in accordance with various embodiments of the invention. As shown in FIG. 4, an inventory limits violation bar 401 can be displayed showing various inventory limit violations in a supply chain management environment 400.

In addition to the trend chart 402, an inventory projection report 403 can be provided showing detailed information for the violations. For example, the inventory projection report 403 can indicate that the planned inventory for “San Antonio Terminal/CONV Regular” on Jul. 17, 2012 is 125.481 MB, which exceeds the maximum limit.

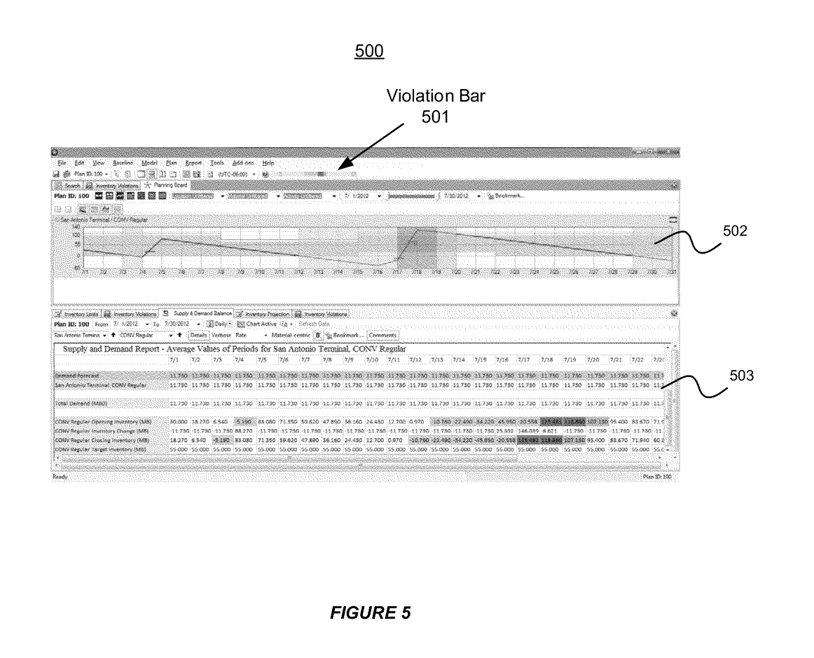

FIG. 5 is an exemplary illustration of displaying a supply & demand balance report corresponding to an inventory limits violation bar, in accordance with various embodiments of the invention. As shown in FIG. 5, an inventory limits violation bar 501 can be displayed showing various inventory limit violations in a supply chain management environment 500.

In addition to the trend chart 502, a supply & demand balance report 503 can be provided showing detailed information for the violations. For example, the supply & demand balance report 503 can indicate that the forecasted demand for “San Antonio Terminal/CONV Regular” on Jul. 18, 2012 is 11.730, and the planned closing inventory for “San Antonio Terminal/CONV Regular” on Jul. 18, 2012 is 118.860 MB, which exceeds the maximum limit.

Interacting with an Inventory Limit Violation Bar

In accordance with various embodiments of the invention, the supply chain scheduling management environment allows the user to interact with the violation bar.

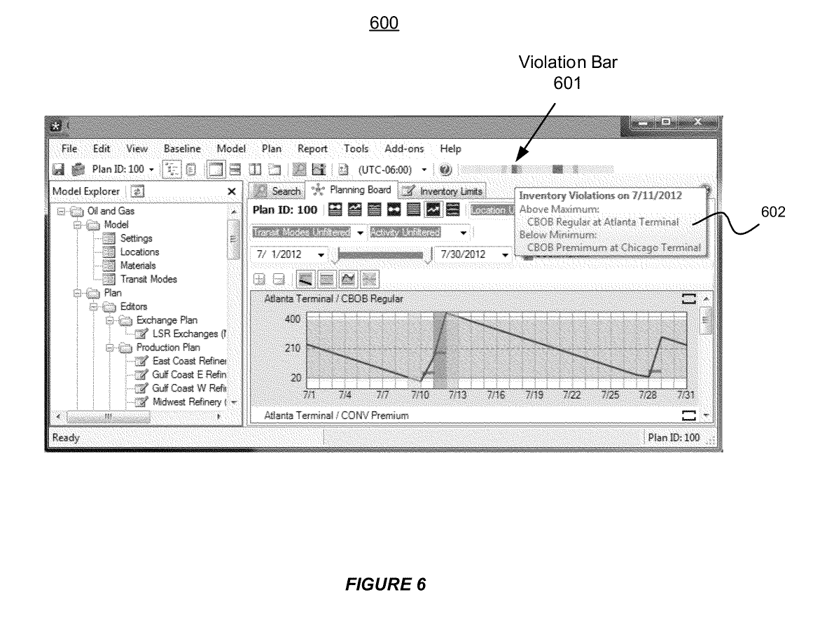

FIG. 6 is an exemplary illustration of displaying detailed information for a violation shown on an inventory limits violation bar, in accordance with various embodiments of the invention. As shown in FIG. 6, when a user places a mouse cursor hover over one or more color coded violations shown on the violation bar 601, a tool tip 602 can pop up describing the violations. (On the other hand, the system may not show the tool tip 602 if the mouse is hovered over the violation bar 601 but not on a color-coded violation).

The tool tip 602 can show the time point along with the detailed description of the violations in text format, with the highest priority violation shown first followed by the lower priority violations. For example, when a user hovers with a mouse cursor over a violation, the tool tip 602 can initially show more than one (e.g. 10 or so) violations, which are the violations with the highest priorities for the time range determined by the mouse hovering.

For As shown in FIG. 6, the tool tip 602 describes two inventory violations on Jul. 11, 2012: a first violation with a higher priority, which indicates that the inventory for “CBOB Regular at Atlanta Terminal” is above maximum, and a second violation with a lower priority, which indicates that the inventory for “CBOB Premium at Chicago Terminal” is blow minimum.

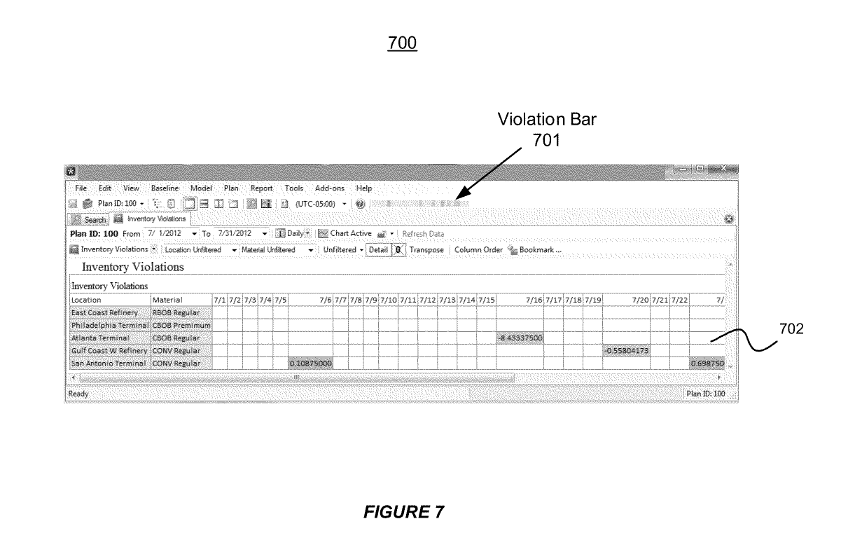

FIG. 7 is an exemplary illustration of launching an inventory limits violation report, in accordance with various embodiments of the invention. As shown in FIG. 7, a detailed inventory violation report 702 is launched when a user place a single left mouse click on the violation bar 701.

The detailed inventory violation report 702 can include detailed information for different violations on various inventories. For example, the detailed inventory violation report 702 can indicate a violation on July 6 for “CONV Regular” at “San Antonio Terminal,” a violation on July 16 for “CBOB Regular” at “Atlanta Terminal,” and a violation on July 20 for “CONV Regular” at “Gulf Coast W Refinery.”

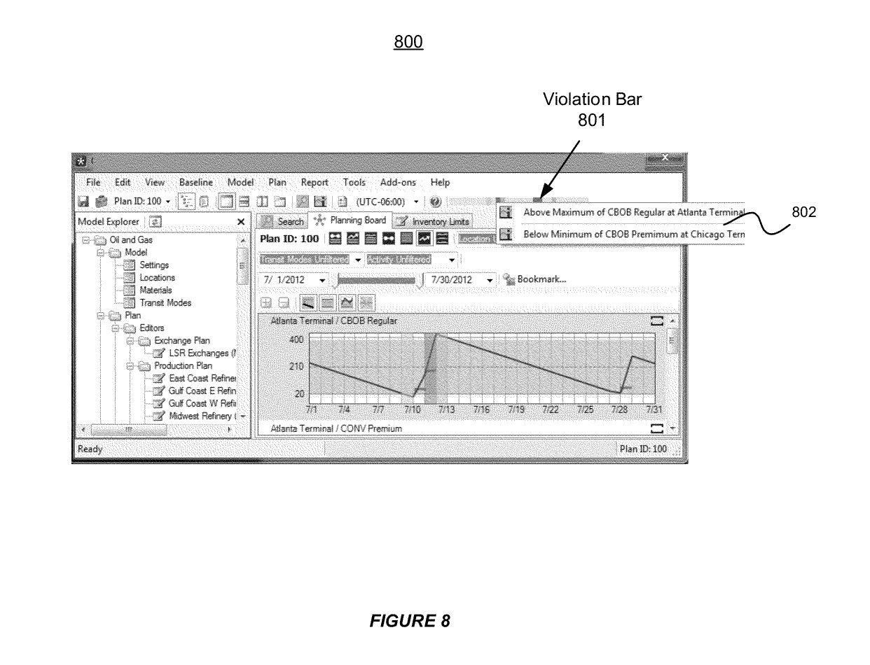

FIG. 8 is an exemplary illustration of displaying an inventory limits violation context menu for a violation shown in a violation bar, in accordance with various embodiments of the invention. As shown in FIG. 8, a context menu 802 is launched when a user hovers with a mouse cursor over a violation on the violation bar and place a single right mouse click on the color-coded violation on the violation bar 801. (On the other hand, the system may not show the context menu 802 if the mouse click is placed on the violation bar 801 but not on any color-coded violation).

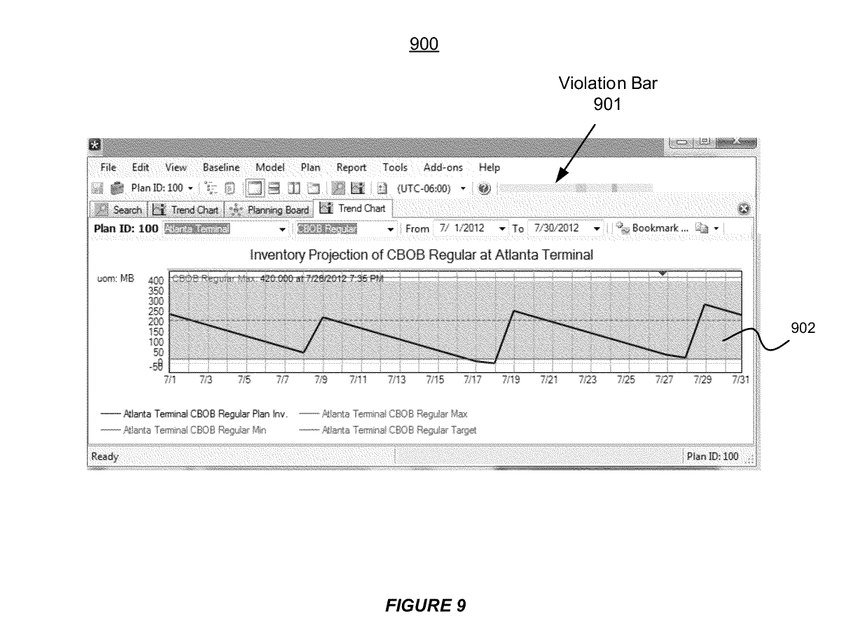

Furthermore, the context menu 802 can show all violations for the time range determined by the mouse hovering. The context menu 802 can list the violations in an order from the highest priority to the lowest priority. When the user further click on a specific violation displayed in the context menu 802, the system can bring up a detailed trend chart showing the violation, which may be shown in FIG. 9.

FIG. 9 is an exemplary illustration of launching a trend chart for a selected violation, in accordance with various embodiments of the invention. As shown in FIG. 9, a detailed trend chart 902 can be displayed to show the violation for the inventory projection of “CBOB Regular at Atlanta Terminal,” when the user further click on the first violation displayed in the context menu 802.

### Updating the Inventory Limit Violation Bar

In accordance with various embodiments of the invention, the supply chain management environment can continuously update the inventory limit violation bar, when the user performs one or more supply chain management operations, e.g. resolving one or more violations.

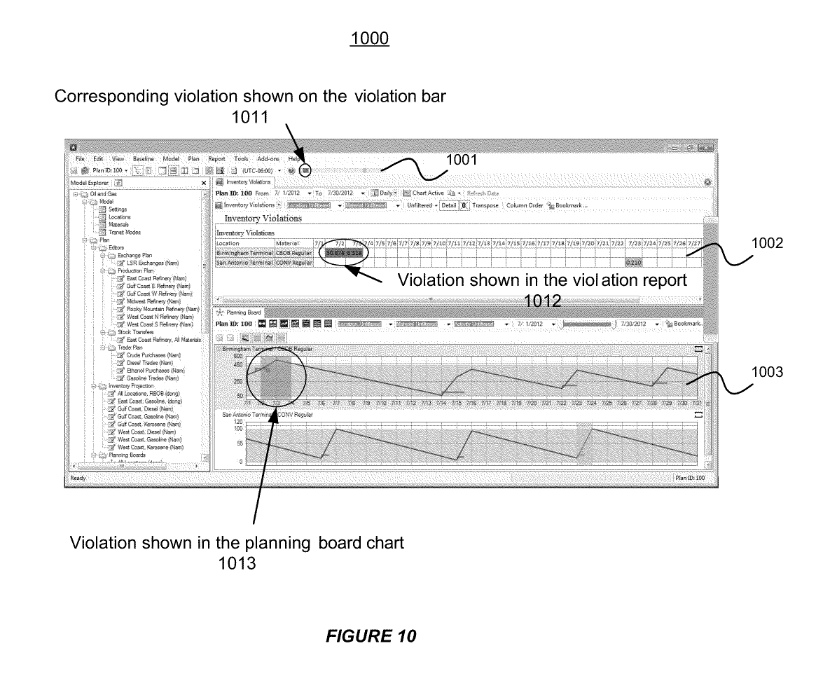

FIG. 10 is an exemplary illustration of displaying an inventory limits violation bar with a warning to be resolved, in accordance with various embodiments of the invention. As shown in FIG. 10, a violation, which is shown in the violation bar 1001 (as emphasized in the ellipse 1011), may occur on the inventory of “Birmingham Terminal/CBOB Regular” between July 2 and July 3. This violation can also be shown in addition to both an inventory violation report 1002 (as emphasized in the ellipse 1012) and a planning board chart 1003 (as emphasized in the ellipse 1013).

In accordance with various embodiments of the invention, there can be different ways that a user can resolve the violation. For example, the user can resolve the violation via modifying a supply chain activity, adjusting the inventory limit, and/or changing the start inventory.

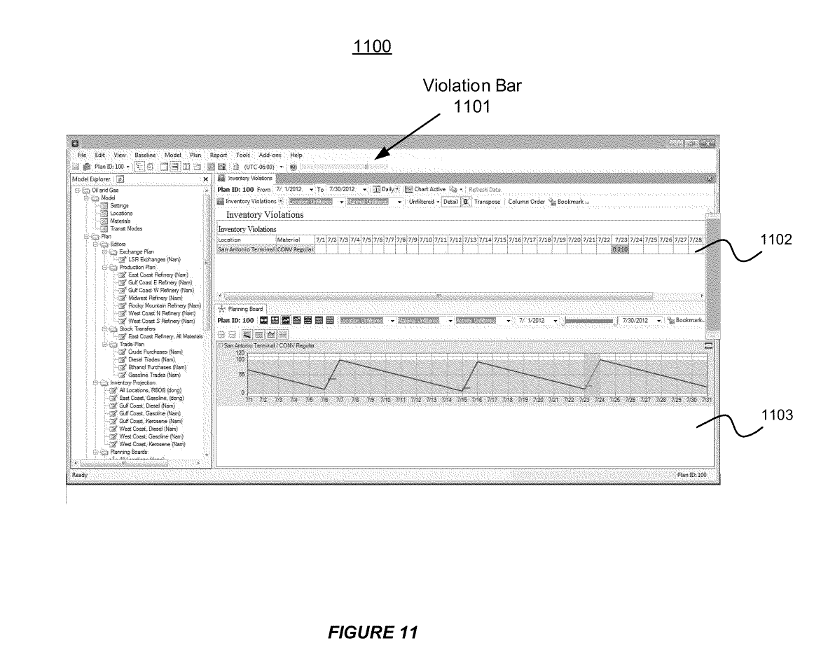

FIG. 11 is an exemplary illustration of displaying an inventory limits violation bar after a warning is resolved, in accordance with various embodiments of the invention. As shown in FIG. 11, after the user resolves the violation (as shown in FIG. 10), the violation bar 1101 can be updated accordingly by removing the violation, in order to be maintained in sync with the inventory violation report 1102 and the planning board chart 1103.

The present invention may be conveniently implemented using one or more conventional general purpose or specialized digital computer, computing device, machine, or microprocessor, including one or more processors, memory and/or computer readable storage media programmed according to the teachings of the present disclosure. Appropriate software coding can readily be prepared by skilled programmers based on the teachings of the present disclosure, as will be apparent to those skilled in the software art.

One embodiment includes a computer program product which is a storage medium (media) having instructions stored thereon/in which can be used to program a computer to perform any of the features present herein. The storage medium can include, but is not limited to, any type of disk including floppy disks, optical discs, DVD, CD-ROMs, micro drive, and magneto-optical disks, ROMs, RAMs, EPROMs, EEPROMs, DRAMs, flash memory of media or device suitable for storing instructions and/or data stored on any one of the computer readable medium (media), the present invention can include software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, execution environments/containers, and user applications.

Embodiments of the present invention can include providing code for implementing processes of the present invention. The providing can include providing code to a user in any manner. For example, the providing can include transmitting digital signals containing the code to a user; providing the code on a physical media to a user; or any other method of making the code available.

Embodiments of the present invention can include a computer implemented method for transmitting code which can be executed at a computer to perform any of the processes of embodiments of the present invention. The transmitting can include transfer through any portion of a network, such as the Internet; through wires, the atmosphere or space; or any other type of transmission. The transmitting can include initiating a transmission of code; or causing the code to pass into any region or country from another region or country. For example, transmitting includes causing the transfer of code through a portion of a network as a result of previously addressing and sending data including the code to a user. A transmission to a user can include any transmission received by the user in any region or country, regardless of the location from which the transmission is sent.

Embodiments of the present invention can include a signal containing code which can be executed at a computer to perform any of the processes of embodiments of the present invention. The signal can be transmitted through a network, such as the Internet; through wires, the atmosphere or space; or any other type of transmission. The entire signal need not be in transit at the same time. The signal can extend in time over the period of its transfer. The signal is not to be considered as a snapshot of what is currently in transit.

The forgoing description of preferred embodiments of the present invention has been provided for the purposes of illustration and description. It is not intended to be exhaustive or to limit the invention to the precise forms disclosed. Many modifications and variations will be apparent to one of ordinary skill in the relevant arts. For example, steps preformed in the embodiments of the invention disclosed can be performed in alternate orders, certain steps can be omitted, and additional steps can be added. The embodiments where chosen and described in order to best explain the principles of the invention and its practical application, thereby enabling others skilled in the art to understand the invention for various embodiments and with various modifications that are suited to the particular used contemplated. It is intended that the scope of the invention be defined by the claims and their equivalents.

What is claimed is:

1. A method to support supply chain management, comprising:
displaying a violation bar on a graphical user interface, wherein the violation bar operates to show one or more violations in a supply chain management environment; and
allowing a user to interact with the violation bar in order to obtain detailed information on the one or more violations.

2. The method according to claim 1, further comprising:
defining a supply chain time window, wherein the supply chain time window allows a portion of supply chain forecast from a start time to an end time.

3. The method according to claim 2, further comprising:
detecting one or more violations occurred within the supply chain time window in the supply chain management environment.

4. The method according to claim 3, further comprising:
allowing the one or more violations occurred within the supply chain time window to be shown on the violation bar along a time line from the start time to the end time.

5. The method according to claim 1, further comprising:
using different colors to show the one or more violations in different priorities in the supply chain management environment.

6. The method according to claim 1, further comprising:
allowing a user to resolve the one or more violations and updating the violation bar continuously to reflect one or more current violations.

7. The method according to claim 1, further comprising:
displaying a tool tip describing a violation at a time point when a user hover a cursor over the particular violation on the violation bar.

8. The method according to claim 1, further comprising:
displaying a detailed inventory violation report after receiving a mouse click event on the violation bar.

9. The method according to claim 1, further comprising:
displaying a context menu showing one or more violations after receiving a mouse click event on the violation bar.

10. The method according to claim 8, further comprising:
bringing up a trend chart showing a particular violation that is selected from the context menu.

11. A system to support supply chain management, comprising:
one or more microprocessors;
a supply chain management platform running on the one or more microprocessors, wherein the supply chain management platform operates to perform the steps of:
displaying a violation bar on a graphical user interface, wherein the violation bar operates to show one or more violations in a supply chain management environment; and
allowing a user to interact with the violation bar in order to obtain detailed information on the one or more violations.

12. The system according to claim 11, wherein:
the supply chain management platform allows a user to define a supply chain time window, wherein the supply chain time window allows a portion of supply chain forecast from a start time to an end time.

13. The system according to claim 12, wherein:
the supply chain management platform operates to detect one or more violations occurred within the supply chain time window in the supply chain management environment.

14. The system according to claim 13, wherein:
the supply chain management allows the one or more violations occurred within the supply chain time window to be shown on the violation bar along a time line from the start time to the end time.

15. The system according to claim 11, wherein:
the supply chain management operates to use different colors to show the one or more violations in different priorities in the supply chain management environment.

16. The system according to claim 11, wherein:
the supply chain management allows a user to resolve the one or more violations and updating the violation bar continuously to reflect one or more current violations.

17. The system according to claim 11, wherein:
the supply chain management operates to display a tool tip describing a violation at a time point when a user hover a cursor over the particular violation on the violation bar.

18. The system according to claim 11, wherein:
the supply chain management operates to display a detailed inventory violation report after receiving a mouse click event on the violation bar.

19. The system according to claim 11, wherein:
the supply chain management operates to
display a context menu showing one or more violations after receiving a mouse click event on the violation bar; and
bring up a trend chart showing a particular violation that is selected from the context menu.

20. A machine readable medium having instructions stored thereon that when executed cause a system to perform the steps comprising:
displaying a violation bar on a graphical user interface, wherein the violation bar operates to show one or more violations in a supply chain management environment; and
allowing a user to interact with the violation bar in order to obtain detailed information on the one or more violations.
